(19) United States
(12) Patent Application Publication
(10) Pub. No.: US 2014/0372369 A1
(43) Pub. Date: Dec. 18, 2014

(54) Managing Changes to Shared Electronic Documents Using Change History

(71) Applicant: Microsoft Corporation, Redmond, WA (US)

(72) Inventors: Alexander Babanov, Seattle, WA (US); Dan Y. Khen, Bellevue, WA (US); Nicholas Ryan, Redmond, WA (US); David Samuel Gensburg, Seattle, WA (US); Harold Duane Campbell, Sammamish, WA (US); Konrad Tupaj, Kirkland, WA (US); Dmitri Kotchetov, Redmond, WA (US); Kartik Nathan, Bellevue, WA (US); Douglas Allen Mangini, Redmond, WA (US); Jenefer Monroe, Seattle, WA (US)

(21) Appl. No.: 13/918,671

(22) Filed: Jun. 14, 2013

(51) Int. Cl. G06F 17/30

(52) U.S. Cl. CPC G06F 17/30581
USPC 707/608

(57) ABSTRACT

Embodiments are disclosed for a system to manage changes to a shared electronic document. In embodiments, a client side method is used to manage changes to a shared electronic document. The method includes receiving a change to a locally stored rendition of a shared electronic document, and updating a change history. In embodiments, the change history captures the change made to the locally stored rendition of a shared electronic document. The method also includes sending information regarding the change to a server, receiving information regarding a master copy of the shared electronic document, and determining based on the received information the change was accepted by the server and applied to the master copy of the shared electronic document.

### BACKGROUND

Networked systems, such as the Internet, provide the opportunity for people to collaborate using computers or terminals connected to a network. These people, known as users, may collaborate with other users with the aid of shared electronic documents. Sharing electronic documents occurs when one user has access to an electronic document at the same time that another user has access to an electronic document. For example, a user might interact with a spreadsheet at the same time another user interacts with that same spreadsheet.

During the course of sharing electronic documents, users often desire to change the shared electronic document. For example, a shared electronic document may be a spreadsheet, and a user may desire to change the contents of a cell. As such, a user may use a computer system or terminal, e.g., a client, to change the contents of the cell. During that same time, however, another user may wish to enter a different change to the spreadsheet. Two clients attempting to change a shared electronic document at the same time, however, often results in a conflict.

Resolving this conflict traditionally required each client to maintain a connection to the shared electronic document. For example, each client would request to change the shared electronic document, and a server that stored the shared electronic document would respond with either a notice of acceptance or notice rejection regarding the change. This constant communication between a client and a server provided the client with information regarding the acceptance or denial of the change, but the constant communication increased network traffic.

Alternatively, operational transformations were used in an attempt to resolve conflicts. Operational transformations provide information to other clients regarding a change one client is attempting to make. The client that is making the change sends the operational transformations to other clients accessing the shared electronic document. The other clients may use the operational transformations in an attempt to replicate the effect of the change. However, operational transformations do not scale well when a client attempts to make complex changes, and operational transformations may not function well when applied out of order relative to other changes.

It is with respect to these and other general considerations that embodiments have been made. Also, although relatively specific problems have been discussed, it should be understood that the embodiments should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Embodiments are disclosed for a system to manage changes to a shared electronic document. In embodiments, a client side method is used to manage changes to a shared electronic document. The method includes receiving a change to a locally stored rendition of a shared electronic document, and updating a change history. In embodiments, the change history captures the change made to the locally stored rendition of a shared electronic document. The method also includes sending information regarding the change to a server, receiving information regarding a master copy of the shared electronic document, and determining based on the received information the change was accepted by the server and applied to the master copy of the shared electronic document.

In another embodiment, a computer readable storage medium is used to store instructions that, when executed perform a method. In embodiments, the method is used to manage changes to a shared electronic document. The message includes receiving a change to a locally stored rendition of a shared electronic document, and updating a change history. In embodiments, the change history captures the change made to the locally stored rendition of a shared electronic document. The method also includes sending information regarding the change to a server, receiving information regarding a master copy of the shared electronic document, and determining based on the received information the change was accepted by the server and applied to the master copy of the shared electronic document.

In other embodiments, a system to manage changes to a shared electronic document is used. The system includes a server that sends master document information regarding a master copy of a shared electronic document using an outgoing communication channel and a master change history. Additionally, the server is configured to receive information regarding a client's locally stored rendition of shared electronic document using a client to server communication channel. Additionally, a central authority module is mounted on the server. In embodiments, the central authority determines whether to update the master copy of a shared electronic document.

### BRIEF DESCRIPTION OF THE DRAWINGS

Non-limiting and non-exhaustive embodiments are described with reference to the following Figures in which:

FIG. 1 illustrates an embodiment of a networked system for managing changes to a shared electronic document using change history.

FIG. 2 illustrates an embodiment of using change history to manage changes to a master document

FIG. 3 illustrates an embodiment of client modules and server modules configured to manage changes to a master document.

FIG. 4 illustrates a method for a client to determine whether to change has been accepted or rejected.

FIG. 5 illustrates an embodiment of a method of a server determining whether to update a master copy of a shared electronic document.

FIG. 6 illustrates one example of a suitable operating environment in which one or more of the present embodiments may be implemented.

FIG. 7A illustrates one embodiment of a mobile computing device in which various embodiments may be implemented.

FIG. 7B is a block diagram illustrating the architecture of one embodiment of a mobile computing device suitable for implementing various embodiments.

FIG. 8 is a simplified block diagram of a distributed computing system in which embodiments of the present invention may be practiced.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems, or devices. Accordingly, embodiments may take the form of a hardware implementation, an entirely software implementation, or an implementation combining software and hardware aspects. The following detailed description is, therefore, not to be taken in a limiting sense.

Users may interact with various types of electronic documents in a networked environment. Some examples of electronic documents include spreadsheets, presentation slides, word processing documents, and image documents. Though this disclosure may make references to electronic documents in the context of spreadsheets, such disclosure should not be taken in a limiting sense. For example, this disclosure may use the word “change history” in reference to changes to a spreadsheet. However, the concept of tracking changes may be equally applied to presentation slides, word processing documents, and image documents.

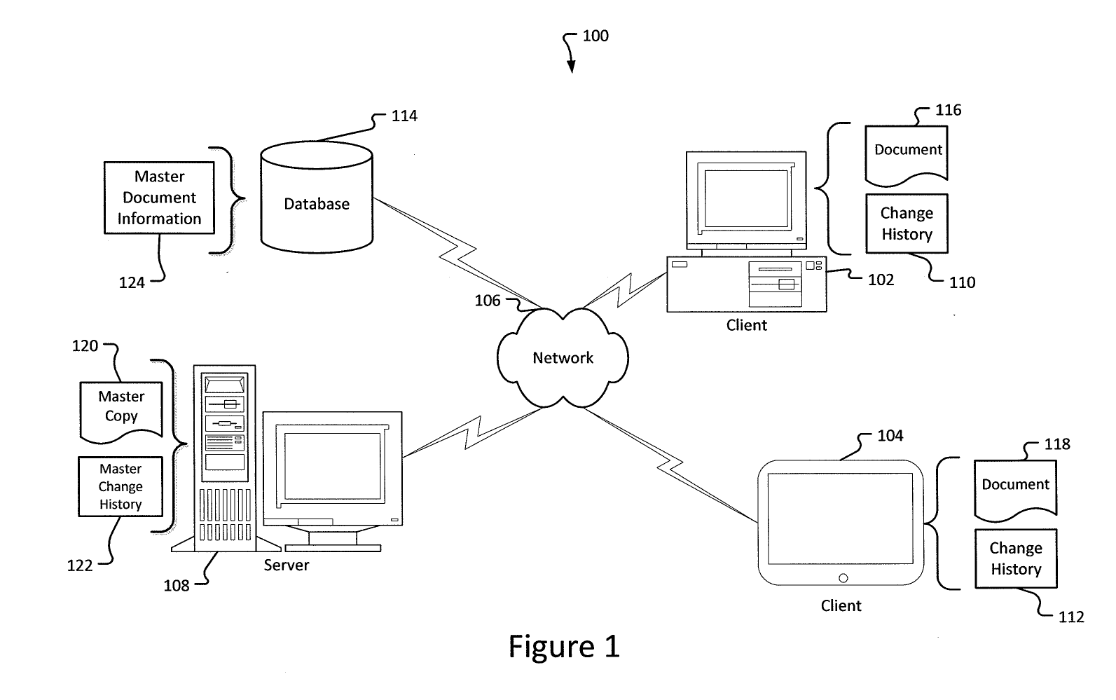

FIG. 1 illustrates an embodiment of a networked system 100 for managing changes to a shared electronic document using change history. As illustrated, a first client 102 and a second client 104 are connected to a server 108 through a network 106. A database 114 is connected to the network 106 as well.

A first client 102 and a second client 104 connect to a network 106. The network connection may be intermittent. The clients 102 and 104 may be any computer system including, wired and wireless computing systems, mobile computing systems (e.g., mobile telephones, netbooks, tablet or slate type computers, and laptop computers), and desktop computers, and the like. As illustrated, the first client computer 102 is a desktop computer, and the second client computer 104 is a tablet. However, one skilled in the art will appreciate that clients 102 and 104 are merely exemplary devices and other devices may be used to achieve the functionality described herein.

In embodiments, the first client 102 has a locally stored rendition of the shared electronic document 116. Users may interact with the client 102 to make changes to the locally stored rendition of a shared electronic document 116. Additionally, the first client 102 has a change history 110. The change history 110 is the history of changes made to the locally stored rendition of the shared electronic document 116. The change history 110 is updated when the first client 102 changes the locally stored rendition of the shared electronic document 116. In embodiments, information regarding a change is sent through the network 106 to the server 108 when the first client 102 has an active connection to the network 106. For example, this information may be the entire change history 110, or the information may be portions of the change history 110. Information regarding a change that is sent to the server 108 may alert the server 108 that the client 102 is attempting to make a change to a master copy of the shared electronic document, e.g., master copy 120.

In an alternative embodiment, information regarding a change is communicated indirectly to the server. In an embodiment, for example, the information regarding a change is sent through the network 106 to a database 114. The server 108 then accesses the information regarding a change by accessing the database 114.

Similarly, the second client 104 has a locally stored rendition of the shared electronic document 118. Additionally, the second client 104 stores a change history 112. The change history 112 is the history of changes made to the rendition of the shared electronic document 118. The change history 112 is updated when the second client 104 changes the locally stored rendition of the shared electronic document 118. In embodiments, information regarding a change is sent through the network 106 to the server 108 when the second client 104 has an active connection to the network 106. For example, this information may be the entire change history 112, or the information may be portions of the change history 112. Information regarding a change that is sent to the server 108 may alert the server 108 that the second client 104 is attempting to make a change to a master copy of the shared electronic document, e.g., master copy 120. Similar to the first client 102, the information regarding a change may communicated indirectly to the server 108.

The server 108 receives and responds to the requests of one or more clients, such as clients 102 and 104. In some embodiments, these requests may be communicated indirectly to the server 108. In an embodiment, the server 108 is a computer, or series of computers, linked together that serves the requests of other computer programs, such as computer programs of the client(s). The server 108 includes applications running to serve the needs of clients, such as the first client 102 and the second client 104. The server 108 also typically includes physical hardware such as one or more computer processors, memory, one or more hard drives, communication connections, and input/output devices.

Additionally, the server 108 performs various functions related to managing changes to a master copy of the shared electronic document 120. For example, the server 108 stores a master copy of the shared electronic document 120. Additionally, the server 108 stores a master change history 122. The master change history 122 is updated when the server 108 changes the master copy 120.

In an embodiment, the server 108 sends information 124 regarding the master copy 120 to a database 114 through the network 106. This information 124 may include the master change history 122 and the master copy 120.

The database 114 is an organized collection of data. Typically a database management system is employed to manage the collection, organization, and retrieval of the data stored on the database 114. As illustrated, the database 114 is a networked database, though it need not be. In embodiments, the database 114 stores information related to servicing the needs of the client. Additionally, the database 114 may store information related to the first client 102 and the second client 104. Further, the database 114 stores information related to the server. The database 114 stores the master document information 124. The sever may also store information related to proposed changes to a master copy of a shared electronic document 120.

The clients 102 and 104 may retrieve information 124 regarding the master copy 120 from the database 114. In embodiments, the information 124 is used by clients 102 and 104 to update a locally stored version of the change history, such as change history 110 of a first client 104. Client 104 will also alter its locally stored rendition of shared electronic document 116 to correspond to the changes reflected by the information 124. For example, the master document information 124 may include information related to the master copy of the shared electronic document 120 and the master change history 122. In embodiments, the client will use such information to determine how to update its version of the shared electronic document.

Additionally, the server 108 receives and processes information regarding a change a client has made to the clients locally stored rendition of the shared electronic document. This information will be referred to as a client's proposed change information. Such proposed change information may include the change histories (or data indicative of change histories) from clients, such as a change history 110 from a first client 102 and a change history 112 from a second client 104. One way for the server 108 to change the master copy 102 is for the server 108 to apply a client's proposed changes to the master copy 120 that correspond to a client's change history. For example, the server 108 may first receive a first client's 102 proposed change information, and the proposed change information may include a change history 110 from a first client 102. In an embodiment, the server 108 may determine that the change history 110 corresponds to changes that should be made to the master document 120. Accordingly, the server 108 applies the changes to a master copy of the shared electronic document 120, and the server updates the master change history 122 to correspond to the changes that have been made. As such, the master change history 122 will correspond to the change history 110, and the master copy 120 will be substantially the same as the rendition of the shared electronic document 116.

In other embodiments, the server 108 may reject a proposed client change by declining to update its master change history 122 to correspond a change indicated by a client's proposed change information. For example, a second client 104 may send proposed change information a server 108. The second client's 104 proposed change information may include a change history 112 of a second client 104. Alternatively, the second client's 104 proposed change information may include information that allows the server to identify the proposed change, such as portions of the change history 112. Based on the proposed change information, the server 108 may reject the proposed change. Such a rejection also corresponds to the server 108 declining to change the master copy 120 to reflect the functional changes captured by change history 112.

The term functional change is used to describe an alteration to a shared electronic document that results in altering some aspect of a rendition of shared electronic document and/or master copy of the shared electronic document. For example, a client may apply a change, such as changing cell “A22” (not shown) to a value “ABC,” to a rendition of a shared electronic document. In response, a server may apply a corresponding change to a master copy of the shared electronic document. In this example, the corresponding change would be the server changing cell “A22” to value “ABC” in the master copy of the shared electronic document. As such, in this example, both the master copy of the shared electronic document and the rendition of the shared electronic document have gone through the same “functional change.” Though changing a cell value was used as an example, such an example should not be taking as limiting. Changes to format, file name, chart types, text, headers, footers, metadata, formulas, etc., are all examples of functional changes.

In an embodiment, the clients 102 and 104 may use the master document information 124 stored on a database 124 to determine whether a change has been accepted or rejected. In embodiments, after the server 108 makes changes to the master copy 120 and captures those changes in the master change history 122, the server 108 sends master document information 124 to a database 114. The master document information 124 includes information related to the changes to the master copy 120 and the change history 122. For example, the information 124 may be a copy of the changed document corresponding to a master copy 120 with a list of accepted revisions corresponding to a master change history 122. In embodiments, the client 102 may use the master document information 124 to determine that the locally stored rendition of the shared electronic document 116 is substantially similar to the master copy 120. This may occur by the client 102 comparing the accepted revisions captured in the master document information 124 with its change history 110.

Two documents are substantially similar when the same functional changes have occurred to each document. In an embodiment, substantially similar also means that the functional changes have occurred in a particular order. Accordingly, documents are substantially different when different functional changes have occurred to each document. In an embodiment, a change in order of a functional change is considered a different functional change. In other embodiments, order does not matter.

In an embodiment, a client uses the master document information to determine that a change was rejected. For example, a second client 104 receives the master document information 124. The second client 104 uses the master document information 124 to determine that client 2's local stored rendition of the shared electronic document 118 is different from the master copy 120. The comparison may indicate that the master change history 122 and the change history 112 are substantially different. Such a determination indicates that certain changes the second client 104 attempted to make to the master copy of the shared electronic document 120 have been rejected.

The network 106 that facilitates communication between the between clients, servers, and databases may be one network or a series of connected networks known in the art. There are numerous types of networks that one could employ to allow devices to communicate with each other. Communication may occur through the use of wireless and/or other technologies. For example, the network 106 could be the Internet or a local area network (“LAN”). In a particular embodiment, the network 106 may be a tightly coupled business network where the server system is relatively “dedicated” to a small number of computers in a LAN environment. In embodiments, communication between clients 102 and 104, server 108, and database 114 happen in real time.

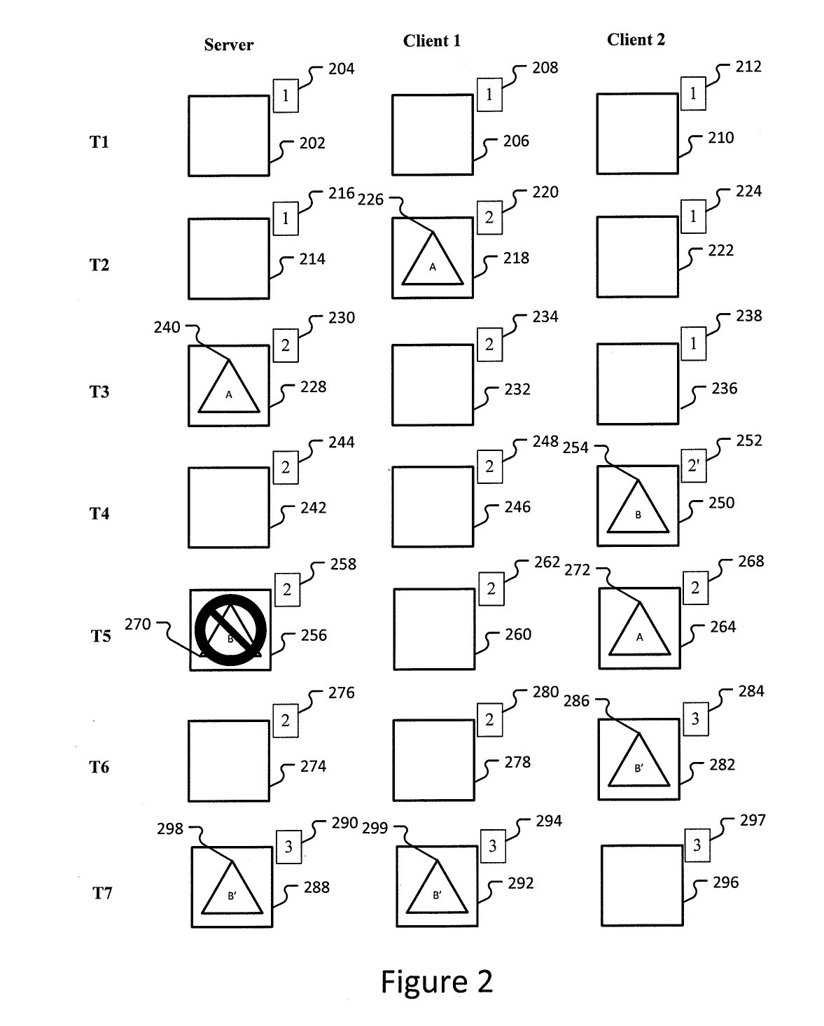

FIG. 2 illustrates an embodiment of using change history to manage changes to a master document. FIG. 2 has three columns, Server, Client 1, and Client 2. Drawings which are located under a column are associated with that column's label. For example, items located under “Server” are associated with a server. Additionally, FIG. 2 has seven rows, T1, T2, T3, T4, T5, T6, and T7. These correspond to seven moments in time. Drawings which are located in a row are associated with that time. For example, an item located in row T3 is associated with time T3.

As such, FIG. 2 generally relates to changes, change history, and change history base states over time. For example, at time T1, a server has a master change history 202 with a server master change history base state 204, a Client 1 has a change history 206 with a Client history base state 208, and a Client 2 has a change history 210 with a Client 2 change history base state 212.

A base state describes the changes that are captured in a change history up to a point in time. For example, a server will store a master copy of a shared electronic document as described with reference to FIG. 1. Associated with that master copy will be a master change history, such as master change history 202. At T1, the changes the master copy has gone through will be captured in a master change history 202. As such, the master change history 202 may be described as having a base state 204 of 1.

Additionally, a Client 1 will store a rendition of a shared electronic document. The Client 1 will also have a change history 206 that captures the changes associated with the rendition of the shared electronic document stored by Client 1. Client 1's change history 206 will have a base state 208. As illustrated, the base state 208 has the same value, i.e., 1, as the master change history's 202 base state 204. This indicates that the functional changes made to the rendition of the shared electronic document stored by Client 1 are the same as those functional changes made to the master copy stored by the Server.

Similarly, Client 2 will have a rendition of a shared electronic document. The change history 210 captures the changes made to that rendition at time T1, and the change history 210 will have a base state 212. As illustrated, the base state 212 is 1. This indicates that the same functional changes have been applied to the rendition of the shared electronic document stored by Client 2, the rendition of the shared electronic document stored by Client 1, and the master copy stored by the Server.

In the embodiment illustrated, time T2 illustrates a point in time after a change 226 has been captured by Client 1's change history 218. Because the change history 218 has been altered to reflect the capture a new change 226, the base state 220 is changed. In this case, the new base state 220 is 2.

The addition of change 226 to Client 1's change history 218 may have resulted from Client 1 making changes to a rendition of a shared electronic document. For example, a shared electronic document may be a spreadsheet, and the change 220 that has been added to the change history 218 may reflect a change to the contents of a cell A2. As illustrated, the functional effect of change 226 (i.e., a change the contents of the cell A2) has been illustrated as “A.”

In an embodiment, as of time T2, no changes have been made to the Server's master change history 214 or Client 2's change history 222. Accordingly, the Server's master change history base state 216 and Client 2's change history base state 224 remain 1. An unchanged base state 216 between T1 and T2 indicates that the master copy of the shared electronic document stored by the server has not changed during the duration of time starting at T1 and ending at T2. Similarly, an unchanged base state 224 between T1 and T2 indicates that the rendition of the shared electronic document stored by the Client 2 has not changed during the duration of time starting at T1 and ending at T2.

Time T3 represents a point in time after Client 1 has communicated the change 226 to the Server, and the Server has applied change 240 to the master change history 228. In embodiments, the change 226 may have been communicated to the Server by Client 1 sending its change history 218 to the Server. In other embodiments, Client 1 sends information regarding the functional change “A,” along with base state 220. Note that the change 240 corresponds to the change 226 made to Client 1's change history 218 at T2. That is, change 240 and change 226 are the same functional change “A.”

In embodiments, the determination for the Server to add the corresponding change 240 to the master change history 228 is made by analyzing base states. For example, the Server may apply a change rule based on a base state analysis. One rule is that the Server will only add a corresponding change 240 to the master change history 228 if, at the time prior to the change history capturing the requesting client's change (in this case, that time is T1), the change history of the requesting client (in this case Client 1) and the master change history had the same base-state.

For example, time T3 represents a time after which such a rule was satisfied. Note, at time T1 the Server's master change history 202 has a base state 204 that is equal to 1. Additionally, Client 1 has a change history 206 with a base state 208 that is also equal to 1. Thus, at time T1, the base state 204 and the base state 208 are equal to the same value. Additionally, time T1 is the time prior to the time that the change 226 was captured in Client 1's change history 218. Consequently, at time T3, a Server employing the aforementioned rule will add change 240, which corresponds to change 226, to master change history 228, and the server will apply the change 240 to master copy of the electronic document. Furthermore, the value of the base state 230 of the master change history 228 will be equal to that of Client 1's change history's 228 base state 220. As illustrated, the value is 2.

At time T3 Client 2's change history has not been updated to reflect the functional change A (which in this example is changing the contents of cell A2). In embodiments, this may occur because Client 2 has temporarily disconnected from the network. Consequently, because Client 2 has not been connected to the network, Client 2 has not received any updates to its change history (or updates that would cause an update to Client 2's change history). For example, Client 2 may not have accessed master document information from a database. Alternatively, the master document information stored in a database may have not been updated to reflect the functional change “A.”

Time T4 represents a Client 2 changing its change history 250 in response to a change 254. In an embodiment where the shared electronic document is a spreadsheet, this may occur because a user changed the format of cell A2 of the spreadsheet. This functional change has been illustrated as “B.” As such, the addition of change 254 to Client 2's change history 250 causes the base state 252 to change from 1 to 2. In an embodiment, the base state 252 is not designated as 2 because the functional change “B” is different from the functional change “A,” and a base state of 2 indicates a functional change of “A.”

At time T4 the Server's master change history 242 and Client 1's change history 246 have not changed since time T3. As such, the Server's base state 244 and Client's base state 248 remain equal to 2, which was the value at time T3.

Time T5 is an example of a Server rejecting a change 270. As illustrated the change 270 corresponds to a functional change “B.” Following the previous example, a functional change “B” represents a change to the format of cell A2.

The Server may use a rule to determine that a change 270 will not be captured by the master change history 256. For example, the rule may be that the Server will only add a corresponding change 270 to the master change history 256 if, prior to the requesting client's change history capturing the requesting client's change (in this case, that time is T3), the change history of the requesting client (in this case Client 1) and the master change history had the same base state. As illustrated, the rule would be broken if the change 270 were captured by master change history 256. The rule is broken because at time T3, which is the time prior to the original change 254 being added to Client 2's change list 250, Client 2's base state 238 was equal to 1. Additionally, at time T3 the base state 230 of the Server was equal to 2. Thus, base state 238 and 230 are not equal. This indicates to the Server that Client 2 had an outdated change history 236 prior to making the change 254. As such, the server would reject the change under the aforementioned rule.

Additionally at T5, as illustrated, Client 2 would have received master document information related to the current state of a master copy of the shared electronic document. This may occur because Client 2 has reconnected to a network. For example, Client 2 may have accessed a database with master document information upon reconnecting to the network. In an embodiment, such information includes information sufficient for Client 2 to determine that a functional change “A” has been made to the master copy of the shared electronic document.

Having received this update, Client 2 may interpret that its proposed change was rejected. Client 2 may interpret this because the master document information indicates that the base state 258 is not equal to 2. Thus, Client 2 would interpret that the change “B” was not accepted by the server, because if the change was accepted the base state 258 would be equal to 2. In other embodiments, the master document information may include information related to the master change history 256, and Client 2 would interpret that change “B” was not included in the master change history 256.

As such, sometime before T5 and after T4 (e.g., T4+ not shown), Client 2 may undo the functional change B to its local stored rendition of the shared electronic document, and remove the functional change B from its change history 264. As such, the base state of the Client 2's change history at time T4+ would be 1.

Time T5 also illustrates a change 272 having been added to Client 2's change history 264. This change 272 corresponds to a functional change “A.” Following this example, the functional change “A” represents a change to the value of cell A2. At this point, Client 2's base state 268 is equal to 2. This is the same as the Server's base state 258 and Client 1's base state 262. Note, at T5 Client 1's change history 260 has not been altered.

Time T6 represents a point in time after Client 2 has applied a change 286 to its change history 282. As illustrated, the functional change is represented by a “B′.” In embodiments, B′ may be a functional change to the format of cell A2. Note, however, the value in cell A2 has previously been changed by functional change “A” in this example. The change 286 is captured by the change history 282. As such, the base state 284 of Client 2's change history 282 is altered. In this example, the base state 284 has changed from 2 to 3.

At time T6 the Server has not updated its master change history 274 since T5, nor has Client 1 updated its change history 278 since T5. As such, the Server's base state 276 and Client 1's base state 280 remain equal to 2.

Time T7 represents a point in time where the Server has applied the functional change B′, change 298, to the master change history 288. In embodiments, this occurs because the change 298 has satisfied a rule. For example, the rule may be that the Server will only add a corresponding change 298 to the master change history 288 if, at the time prior when the requesting client's change was captured by the requesting client's change history (in this case, that time is T5), the change history of the requesting client (in this case Client 2) and the master change history have the same base-state.

Additionally, the Server may have transmitted master document information that included an updated copy of the shared electronic document, the master change history 288, and the base state 290 to a database. Moreover, Client 1 may have retrieved master document information from the database. Client 1 may interpret the information and determine to apply a change 299 which corresponds to the functional change B′. The change 299 is captured by the change history 292. Accordingly, Client 1's change log history base state 294 is updated from 2 to 3.

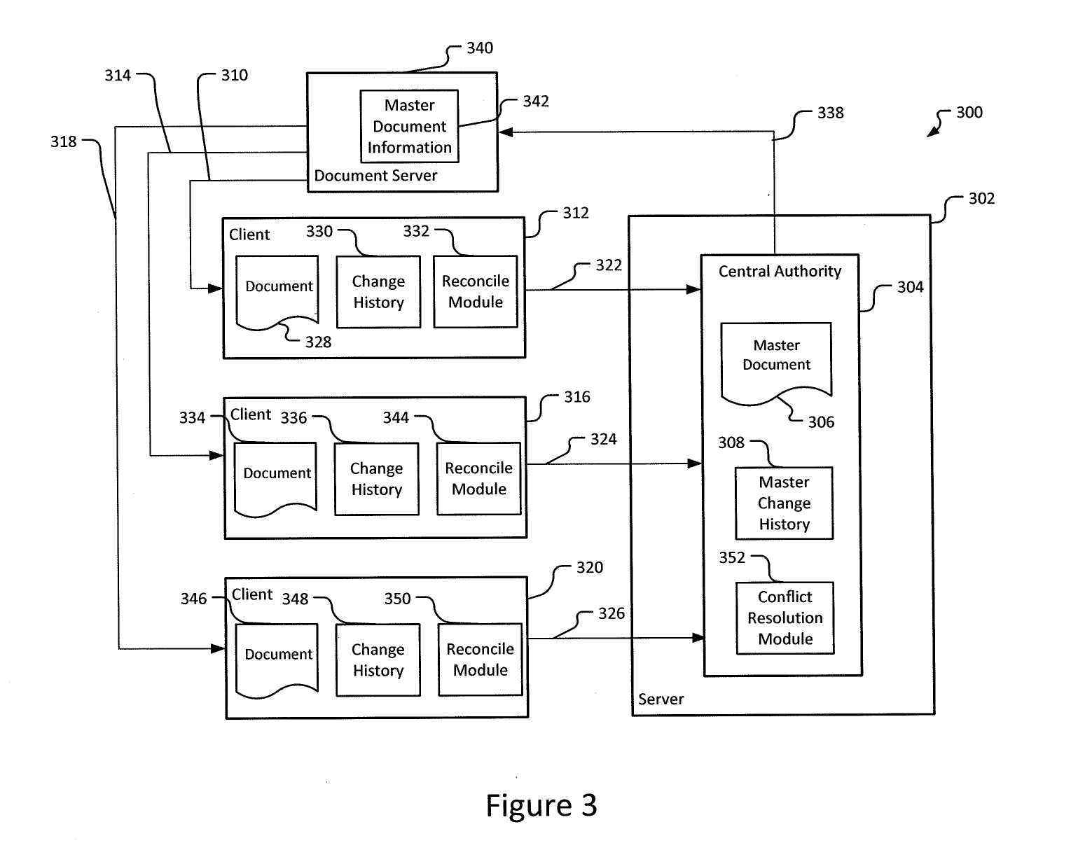

FIG. 3 illustrates an embodiment 300 of client modules and server modules configured to manage changes to a master document. In an embodiment, a server 302 operates a central authority module 304. The central authority module determines whether to make changes to master document 306. In an embodiment, a change to master document 306 will cause the central authority to update the change history 308. In an embodiment, the change to the master document 306 is made by the central authority. The central authority 302 is a module that analyzes and processes any changes requests coming from clients, such as client 312, 316, and 320.

In an embodiment, the server 302 also has a conflict resolution module 352. The conflict resolution module determines whether to accept a change to a master document 306 that is indicated by information coming from a client, such as client 312, 316, or 320.

The server 302 communicates to a document server 340. In embodiments, the server 302 sends information related to the master document 308 to a document server 340 via a communication channel 338.

A document server 340 sends master document information 342 to clients 312, 316, and 320. For example, outgoing communication channel 310 sends information to a client 312, outgoing communication channel 314 sends information to a client 316, and outgoing communication channel 318 sends information to a client 320. An outgoing communication channel is a term used to describe the information sent from the document server 340 to a specific client(s). In an embodiment, the functionality of the document server 340 and the server 302 are performed by the same device.

In an embodiment, clients 312, 316, and 320 send information to the server 302. For example, client 312 sends information to server 302 using a client to server communication channel 322, client 316 sends information to server 302 using a client server communication channel 324, and client 320 sends information to server 302 using a client server communication channel 326. Alternatively, clients 312, 316, and 320 may communicate information indirectly to server 302 by using the document server 340 to store information for later retrieval by the server 302.

The information sent using a client to server communication channel (or an indirect communication scheme) may be information related to a change to a rendition of a shared electronic document. For example, a client 312 may have a rendition of a shared electronic document 328. The client may change the rendition 328. For example, where the shared electronic document is a spreadsheet, the client may alter the value of a cell. In response to this alteration, the client 312 may update the change history 330. At some time after a change has been made to the rendition of the shared electronic document 328, the client 312 may send the change history 330 to the server 302. This change history 330 will have a base state. In other embodiments, the client merely sends information regarding the change and/or the base state information related to the change history 330. Base states are discussed more with reference to FIG. 2.

In embodiments, the change history 330 is received by the server 302. The central authority 304 analyzes the change history 330. In other embodiments, the central authority analyses the information relate to the change. In an embodiment the central authority determines whether to change the master copy of the shared electronic document 306 to correspond to the change indicated in the information related to the change. In alternative embodiments where the change history 330 is sent to the server, the server makes the determination based on the change history 330. Accordingly, the central authority 304 makes a determination on whether to apply the change to the master copy of the shared electronic document 308. Determining whether to apply a change is described more with reference to FIG. 2.

After a change is made to the master copy of the shared electronic document 306, the server 302 will send information related to the master document 306 and/or the master change history 308 to a document server 340. This information will be stored by the document server as master document information 342. In embodiments, the master document information 342 is sent out using the central authority 304. The master document information 342 may be information regarding a change that has been made to the master document 306. Alternatively, the central authority 304 sends to the document server 340 master document information 342 that includes the master change history 308. In an embodiment, master document information 342 will be a copy of the master change history 308. The information related to the master document 306 is sent using an communication channel 338.

Additionally, the central authority 304 may determine not to incorporate a change communicated from a client. For example, a client 312 may have a rendition of a shared electronic document 328. The client may change the rendition 328. For example, where the shared electronic document is a spreadsheet, the client may alter the value of a cell. In response to this alteration, the client 312 updates the change history 330. At some time later, the client 312 sends the server information related to the change, such as the change, change history 330, and/or the base state of the change history 330. The change history 330 may include a base state. Base states are discussed more with reference to FIG. 2.

Upon receipt of the change history 330 and/or information related to change, the central authority 304 may determine not to apply the changes to the master copy of the shared electronic document 306. Determining not to change the master copy of the shared electronic document 306 is discussed further with reference to FIG. 2.

In an embodiment, the client 312 may retrieve master document information 342 from a document server 340. Following the example where the sever 302 rejects a proposed change from client 312, the master document information 342 would not contain information that indicates the change from the client 312 has been accepted. This may occur because a different change has been indicated in the master document information 342. For example, if a determination has been made by central authority 304 that changes captured by client change history 330 will not be incorporated into master change history 308, the client 312 will determine that the client's 312 change has been rejected based on the master document information 342 sent from the document server 340 to the client 312. A client determining that a change has been rejected is discussed more with reference to FIG. 2.

The client 312 may use reconcile module 322 to reconcile the change it attempted to apply. For example, the client 312 may use the master document information 342 to determine that changes were rejected by the central authority 304. For example, change history 330 may contain an ordered history of changes applied to document 328. Additionally, master document information 342 may contain information related to master change history 308 and master document 306. In embodiments, the reconcile module may identify the point in history that the master change history 308 and the change history 330 diverged. The reconcile module may store the additionally changes captured in the change history 330 after the divergence of master change history 308 and change history 330. The reconcile module 322 may then reverse the additionally changes with respect to the document 328. The reconcile module may then apply any new changes captured by the master change history 308 after the divergence. The reconcile module may then analyze the stored additionally changes to determine how to modify the changes and apply to document 328 to maintain the original intent of the user. The reconciliation may be done using logic as is known.

Additional clients, such as client 316 and client 320 may perform in a similar manner as that discussed with reference to FIG. 3. For example, client 316 has a rendition of a shared electronic document 334, a change history 336, and a reconcile module 344. Additionally, client 320 has a rendition of a shared electronic document 346, a change history 348, and a reconcile module 350. As such, client 316 and client 320 are capable of sending information regarding changes to documents, receiving information regarding a master copy of a document, interpreting whether the change was accepted or rejected, and reconciling a rejected change.

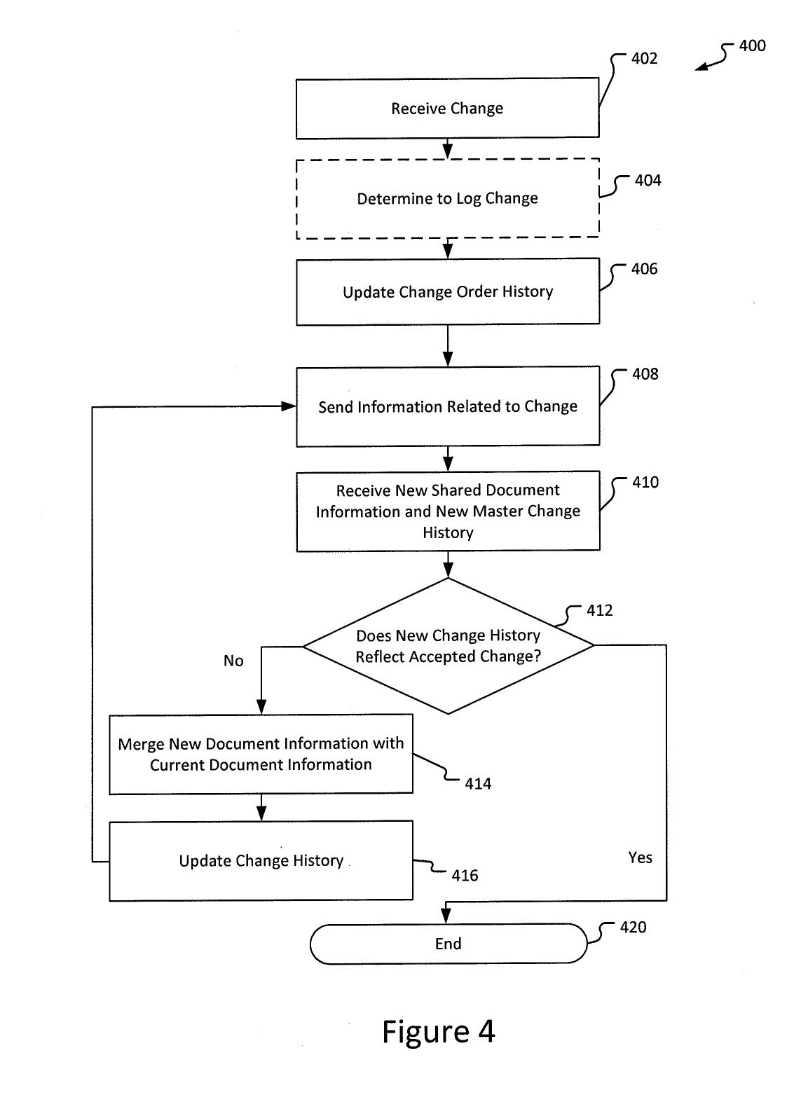

FIG. 4 illustrates a method 400 for a client to determine whether a change has been accepted or rejected. The method 400 beings with a receive change operation 402. In embodiments, this may occur because a user has entered a change to a shared electronic document. For example, a user may use a keyboard or other device to enter information into a shared electronic document. A shared electronic document may be a spreadsheet, and the change may be a user entering a new value into a cell. Those skilled in the art will appreciate that other changes may be received as well.

The method optionally continues to determine to log change operation 404. This may occur when there is logic to determine that certain changes to the rendition of the shared electronic document need not be logged because only the locally stored version of the shared electronic document need be updated. For example, the shared electronic document may be a spreadsheet, and it may be determined that sorting on a particular column is a change that need only be made to the locally cached rendition of the shared electronic spreadsheet. This may occur because it has been determined that other users do not need to see a particular sort.

If it is determined that a change should be logged in the change history, the method continues to an update change history operation 406. A client stores a change history. This change history may describe all of the changes that have occurred to a shared electronic document. For example, the shared electronic document may be a spreadsheet, and the change history may include such information as enter value into cell A1, enter value into cell A2, add row between cell A1 and A2, etc. As such, when a user is changing the locally cached version of the shared electronic document the change history is updated in operation 406.

The method then continues to send information related to change operation 408. In an embodiment, this may include the change history of the client, and the change history may be sent to a server. In alternative embodiments, the information may not be an exact copy of the change and change history, but may be information sufficient for the server to recreate the change and change history on server. In another embodiment, the base state of the change history (or information sufficient for the server to decipher the base state) is included when sending information.

The method then continues to receive new shared document and change history information operation 410. In an embodiment of operation 410, the client will receive information related to the change history of the master copy of the shared electronic document from a document server. Additionally the client may receive information related to the master copy of the shared electronic document so that the client may create a new rendition of the shared electronic document.

The method then continues to determine if change has been accepted operation 412. In embodiments, the operation 412 determines whether the server has updated the master copy of the shared electronic document to correspond with the user change received at step 402. Determining whether the user change has been accepted by the server is discussed more with reference to FIG. 2.

If a determination is made that the change has been accepted, the method 400 ends at operation 420.

If a determination is made that the change had been rejected, the method 400 continues to merge operation 414. In this operation, the client uses a module, such as a reconcile module, to merge the user changes with the current version of the master copy of the shared electronic document received in operation 410. The merging may occur using information received in operation 410. Merging is discussed more with reference to FIG. 3.

After the merge operation, the change history is updated at operation 416. This change history may be updated to remove the original update that occurred in operation 406 and add an update that accurately reflects the merge operation that occurred in operation 414.

The method then loops back to send information related to change 408 where the process continues through operations 410 and 412. The process may repeat until the change is accepted at determination operation 412.

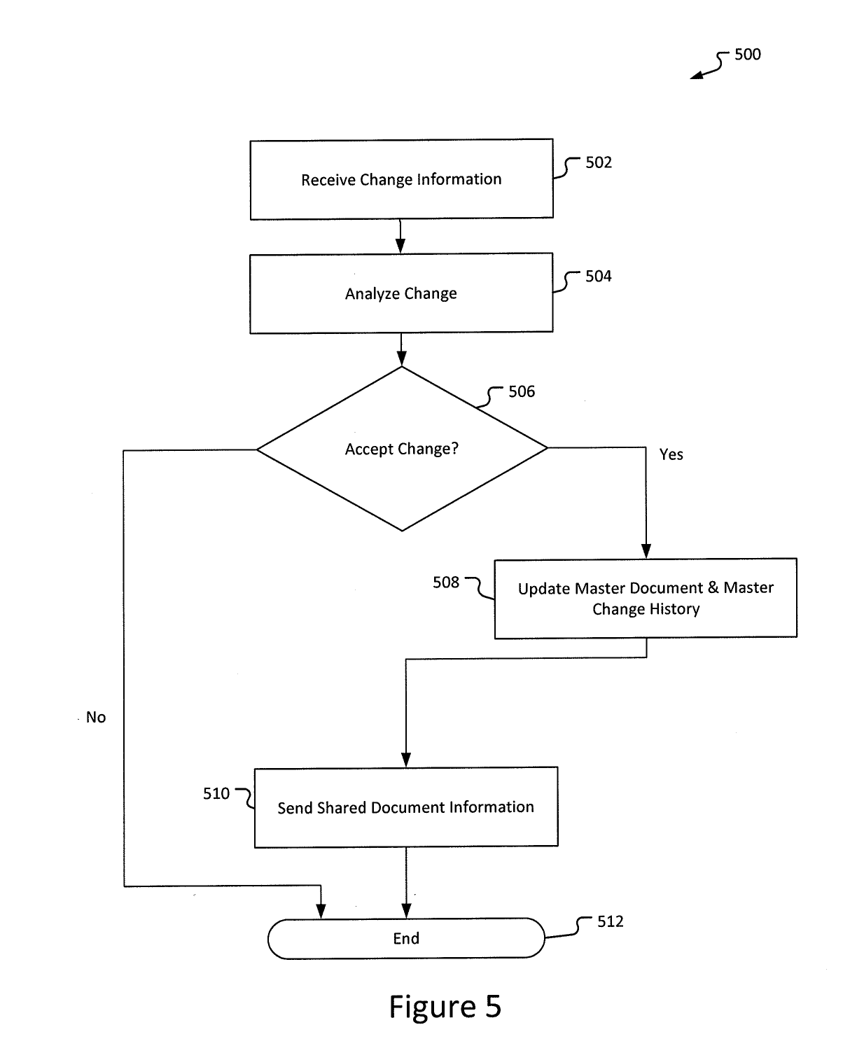

FIG. 5 illustrates an embodiment of a method 500 for a server to determine whether to update a master copy of a shared electronic document.

In embodiments, method 500 begins at receive change information operation 502. The received change information may come from a client that is connected to a network such as the Internet. In an embodiments of method 500, the base state of the client's change history is received along with information sufficient for the server to make a change to a master copy of a shared electronic document. The received change may include information related to change that a user has attempted to make to the client's cached version of a shared electronic document.

The method 500 may continue to analyze change 504. In analyze operation 504, the server analyzes whether the received information indicates that a changed should be rejected or accepted. In an embodiment, the server performs such analysis using base states. Analysis on base states is discussed more with reference to FIG. 2.

Based on the analyses of the information that occurred in operation 504, a determination operation 506 determines whether to accept the change. If the change is rejected, method 500 ends at 512.

If the change is accepted, method 508 proceeds to update master document and master change history operation 508. For example, in method 508 the change may be a functional change of adding a row to a spreadsheet. This change will be applied to the master copy of the shared electronic document stored on by the server. Accordingly, the master change history will be updated to reflect the change.

After operation 508 the method proceeds to operation 510. In embodiments of operation 510, a new copy of the master copy of the shared electronic document, a master document history, and/or a master history base state is sent to a document server that is connected to the network.

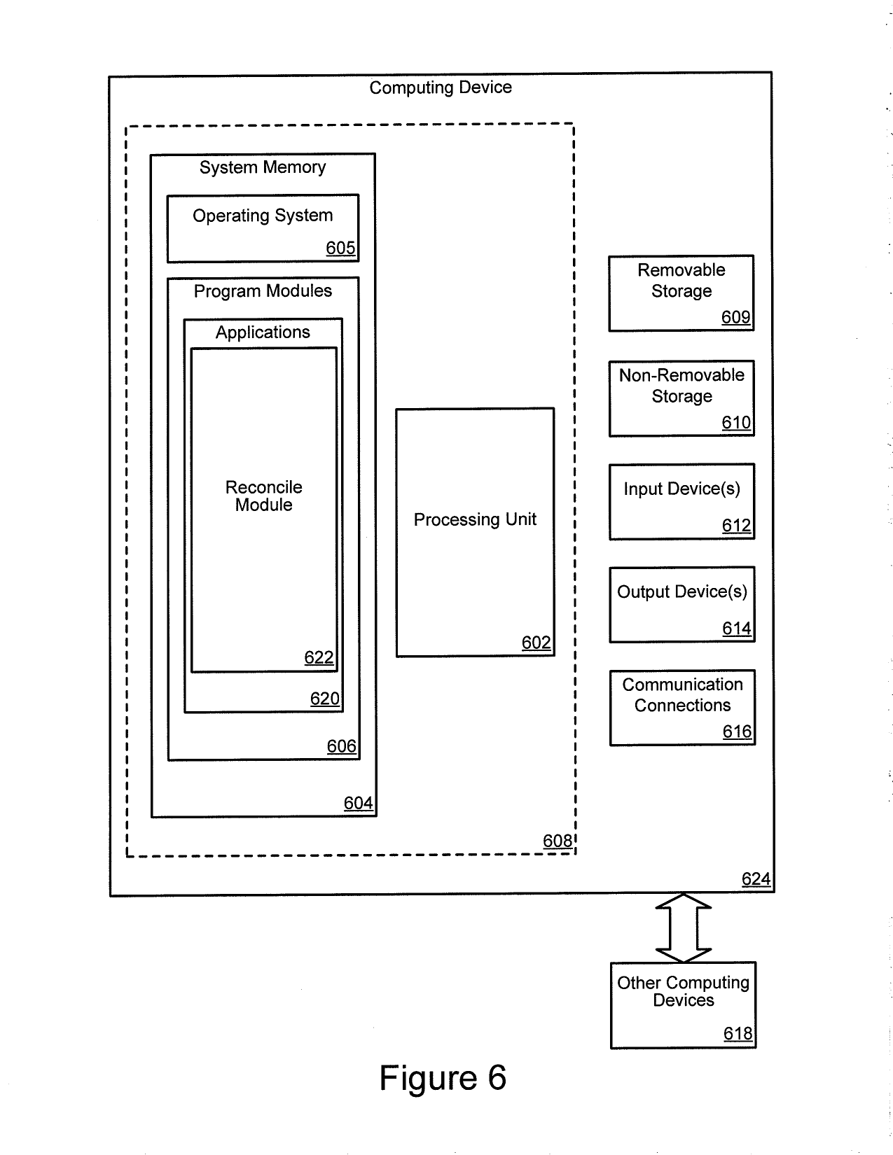

FIG. 6 is a block diagram illustrating physical components (i.e., hardware) of a computing device 624 with which embodiments of the invention may be practiced. The computing device components described below may be suitable for the computing devices described above. In a basic configuration, the computing device 624 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 620 such as the reconcile module 622. The operating system 605, for example, may be suitable for controlling the operation of the computing device 624. Furthermore, embodiments of the invention may be practiced in conjunction with a graphics library, other operating systems, or any other application program and is not limited to any particular application or system. This basic configuration is illustrated in FIG. 6 by those components within a dashed line 608. The computing device 624 may have additional features or functionality. For example, the computing device 624 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, one or more of the stages of the method 900 illustrated in FIG. 9. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 624 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 624 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 624. Any such computer storage media may be part of the computing device 624. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

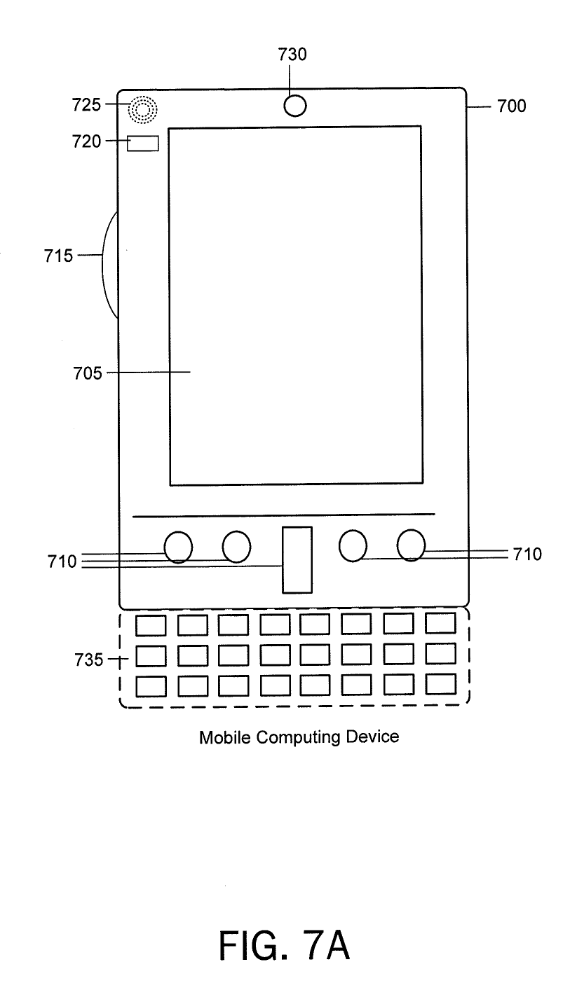

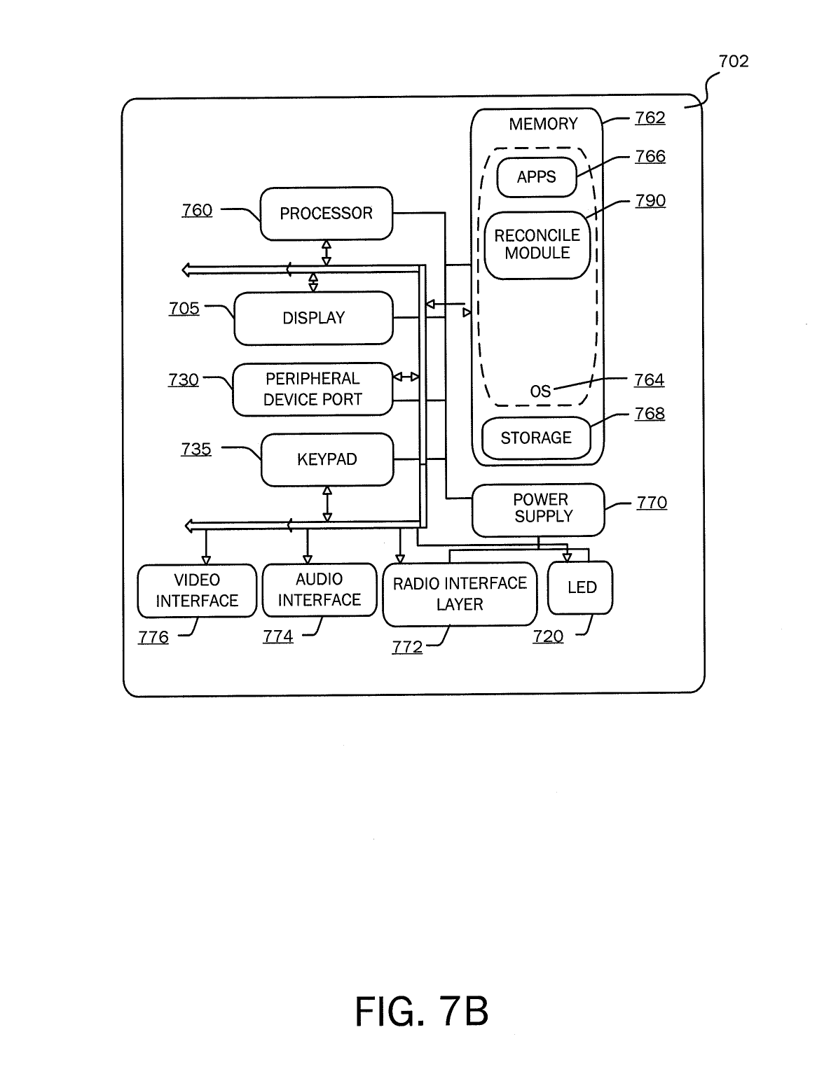

FIGS. 7A and 7B illustrate a mobile computing device 700, for example, a mobile telephone, a smart phone, a tablet personal computer, a laptop computer, and the like, with which embodiments of the invention may be practiced. With reference to FIG. 7A, one embodiment of a mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the reconcile module 790 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present invention, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

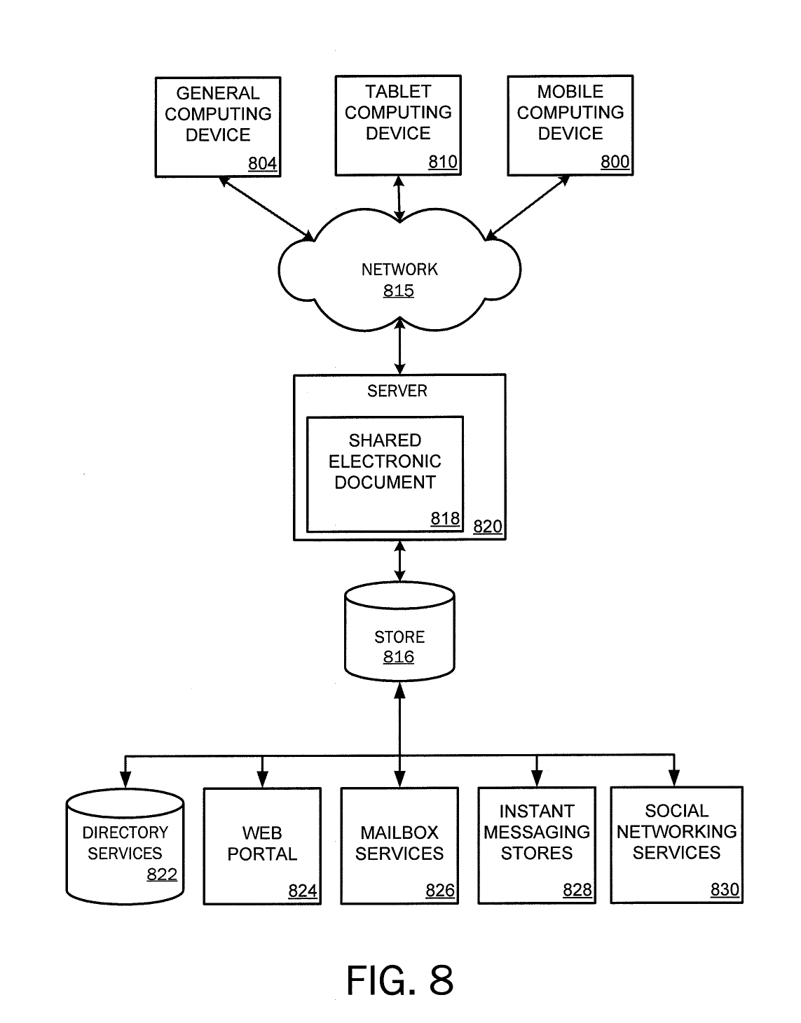

FIG. 8 is a simplified block diagram of a distributed computing system in which embodiments of the present invention may be practiced. Content developed, interacted with, or edited in association with a shared electronic document 818, and may be stored in different communication channels or other storage types. For example, various documents may be stored using a directory service 822, a web portal 824, a mailbox service 826, an instant messaging store 828, or a social networking site 830. A server 820 may provide the shared electronic document 818 to clients. As one example, the server 820 may be a web server providing the shared electronic document 818 over the web. The server 820 may provide the shared electronic document 818 over the web to clients through a network 815. By way of example, the client computing device may be implemented as the computing device 804 and embodied in a personal computer, a tablet computing device 810 and/or a mobile computing device 800 (e.g., a smart phone). Any of these embodiments of the client computing device 804, 810, 800 may obtain content from the store 816.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed:

1. A computer implemented method for a client computer to manage changes to a shared electronic document, the method comprising:
receiving a change to a locally stored rendition of a shared electronic document;
updating a change history, wherein the change history captures the change made to the locally stored rendition of a shared electronic document;
sending information regarding the change to a server;
receiving information regarding a master copy of the shared electronic document; and
determining based on the received information the change was accepted by the server and applied to the master copy of the shared electronic document.

2. The method of claim 1, wherein the shared electronic document is a spreadsheet.

3. The method of claim 1, wherein the sent information regarding the change includes the change history and a change history base state of the locally stored rendition of the shared electronic document.

4. The method of claim 1, further comprising: after the updating the change history, updating a change history base state.

5. The method of claim 1, wherein the determination step includes analyzing the received information to find that a functional change applied to the master copy of the shared electronic document is the same as a functional change applied to the locally stored rendition of the electronically stored document.

6. The method of claim 1, wherein the received information regarding the master copy of the shared electronic document includes a portion of the ordered history of changes applied to the master copy of the shared electronic document.

7. The method of claim 6, wherein the analyzing occurs by comparing the master change history and the change history.

8. A computer-readable storage medium, the computer-readable medium storing computer-executable instructions for a client computer to manage changes to a shared electronic document, the method comprising:
receiving a change to a locally stored rendition of a shared electronic document;
updating a change history, wherein the change history captures the change made to the locally stored rendition of a shared electronic document;
sending information regarding the change to a server;
receiving information regarding a master copy of the shared electronic document; and
determining based on the received information the change was accepted by the server and applied to the master copy of the shared electronic document.

9. The computer-readable storage medium of claim 8, wherein the shared electronic document is a spreadsheet.

10. The computer-readable storage medium of claim 8, wherein the sent information regarding the change includes the change history and a change history base state of the locally stored rendition of the shared electronic document.

11. The computer-readable storage medium of claim 8, further comprising: after the updating the change history, updating a change history base state.

12. The computer-readable storage medium of claim 8, wherein the determination step includes analyzing the received information to find that a functional change applied to the master copy of the shared electronic document is the same as a functional change applied to the locally stored rendition of the electronically stored document.

13. The computer-readable storage medium of claim 8, wherein the received information regarding the master copy of the shared electronic document includes a portion of the ordered history of changes applied to the master copy of the shared electronic document.

14. The computer-readable storage medium of claim 13, wherein the analyzing occurs by comparing the master change history and the change history.

15. A system to manage changes to a shared electronic document comprising:
a server that sends master document information regarding a master copy of a shared electronic document using an outgoing communication channel and a master change history;
the server configured to receive information regarding a client's locally stored rendition of shared electronic document using a client to server communication channel;
a central authority module mounted on the server, wherein the central authority determines whether to update the master copy of a shared electronic document.

16. The system of claim 15, wherein the shared electronic document is a spreadsheet.

17. The system of claim 15, wherein the received information regarding a client's locally stored rendition of a shared electronic document includes a proposed client change, a change history of the locally stored rendition of the shared electronic document, and a change history base state.

18. The system of claim 17, where in the determination step applies a rule.

19. The system of claim 18, wherein the rule requires the central authority to determine not to update the master copy of a shared electronic document if the change history base state was not equal to the master history base state prior to the proposed client change.

20. The system of claim 15, wherein the server sends updates to a document server after each change to the master copy of the shared electronic documents.
